(19) United States
(12) Patent Application Publication
(10) Pub. No.: US 2021/0314164 A1
(43) Pub. Date: Oct. 7, 2021

(54) BLOCK CONTENT EDITING METHODS AND APPARATUSES

(71) Applicant: ALIPAY (HANGZHOU) INFORMATION TECHNOLOGY CO., LTD., Hangzhou (CN)

(72) Inventors: Yuqi Lin, Hangzhou (CN); Changzheng Wei, Hangzhou (CN); Xuyang Song, Hangzhou (CN)

(73) Assignee: ALIPAY (HANGZHOU) INFORMATION TECHNOLOGY CO., LTD., Hangzhou (CN)

(21) Appl. No.: 17/350,569

(22) Filed: Jun. 17, 2021

(30) Foreign Application Priority Data
Aug. 28, 2020 (CN) 202010889932.1

(51) Int. Cl. H04L 9/32; G06F 16/27; G06F 16/23; H04L 9/08; H04L 9/30; H04L 9/14

(52) U.S. Cl. CPC H04L 9/3239; G06F 16/27; G06F 16/23; H04L 2209/38; H04L 9/3073; H04L 9/14; H04L 9/085; H04L 9/0869

(57) ABSTRACT

Disclosed are methods, systems, and media for block content editing in blockchains. One method includes: receiving a transaction to edit original content m of a block of a blockchain to target content m′, wherein a parent hash of the block is recorded in another block of the blockchain and generated based on the original content m, a public key H, and an original random number r; generating a private key X based on private keys x1 to xn; determining a target random number r′ based on the original content m, the target block m′, the original random number r, and the private key X, wherein a hash value generated using the target content m′, the public key H, and the target random number r′ is the same as the parent hash; and updating the original content m to the target content m′.

### CROSS-REFERENCE TO RELATED APPLICATIONS

This application claims priority to Chinese Patent Application No. 202010889932.1, filed on Aug. 28, 2020, which is hereby incorporated by reference in its entirety.

### TECHNICAL FIELD

One or more embodiments of the present specification relate to the field of blockchain technologies, and in particular, to block content editing methods and apparatuses.

### BACKGROUND

Blockchain technologies (also referred to as distributed ledger technologies) are decentralized distributed database technologies, characterized by de-centrality, openness and transparency, tamper-resistance, trustiness, etc., and are applicable to many application scenarios with high demands on data reliability.

### SUMMARY

In view of this, one or more embodiments of the present specification provide block content editing methods and apparatuses.

To achieve the objectives, one or more embodiments of the present specification provide the following technical solutions:

According to a first aspect of the one or more embodiments of the present specification, a block content editing method is provided, including the following: a blockchain node Bi receives a block editing transaction, which is used to edit original block content m of a block Qi to target block content m′, wherein a parent hash corresponding to the block Qi is recorded in a block header of a block Qi+1, the parent hash is generated through calculation by using original block content m, a public key H, and an original random number r, the public key H is generated through calculation by using node public keys h1 to hn respectively corresponding to blockchain nodes B1 to Bn, and i□[1, n] and i is a positive integer; the blockchain node Bi executes a smart contract that generates a random number when determining that a consensus on the block editing transaction succeeds, wherein the smart contract is used to execute secure multi-party computing related to node private keys x1 to xn respectively corresponding to the blockchain nodes B1 to Bn to generate a private key X; and determine corresponding target random number r′ based on the original block content m, the target block content m′, the original random number r, and the private key X, wherein a hash value generated through calculation by using the target block content m′, the public key H, and the target random number r′ is the same as the parent hash; and the blockchain node Bi updates the original block content m to the target block content m′ and the original random number r to the target random number r′.

According to a second aspect of the one or more embodiments of the present specification, a block content editing apparatus is provided. The block content editing apparatus can include: a receiving unit, configured to enable a blockchain node Bi to receive a block editing transaction, which is used to edit original block content m of a block Qi to target block content m′, wherein a parent hash corresponding to the block Qi is recorded in a block header of a block Qi+1, the parent hash is generated through calculation by using original block content m, a public key H, and an original random number r, the public key H is generated through calculation by using node public keys h1 to hn respectively corresponding to blockchain nodes B1 to Bn, and i □[1, n] and i is a positive integer; an execution unit, configured to enable the blockchain node Bi to execute a smart contract, which is used to generate a random number when determining that a consensus on the block editing transaction succeeds, wherein the smart contract is used to execute secure multi-party computing related to node private keys x1 to xn respectively corresponding to the blockchain nodes B1 to Bn to generate the private key X; and determine corresponding target random number r′ based on the original block content m, the target block content m′, the original random number r, and the private key X, wherein a hash value generated through calculation by using the target block content m′, the public key H, and the target random number r′ is the same as the parent hash; and an updating unit, configured to enable the blockchain node Bi to update the original block content m to the target block content m′ and the original random number r to the target random number r′.

According to a third aspect of the one or more embodiments of the present specification, a blockchain node is provided, including: a processor; and a memory configured to store a processor-executable instruction.

The processor implements the method described in the first aspect by executing the executable instruction.

According to a fourth aspect of the one or more embodiments of the present specification, a computer-readable storage medium is provided, and the storage medium stores a computer instruction. The steps of the method described in the first aspect are implemented when the instruction is executed by a processor.

### BRIEF DESCRIPTION OF DRAWINGS

FIG. 1 is a schematic diagram illustrating a blockchain structure according to an example embodiment;

FIG. 2 is a flowchart illustrating a block content editing method according to an example embodiment;

FIG. 3 is a schematic diagram illustrating smart contract creation according to an example embodiment;

FIG. 4 is a schematic diagram illustrating smart contract invocation according to an example embodiment;

FIG. 5 is a schematic structural diagram illustrating a device according to an example embodiment; and

FIG. 6 is a block diagram illustrating a block content editing apparatus according to an example embodiment.

### DESCRIPTION OF EMBODIMENTS

The example embodiments are described in detail here, and examples of the embodiments are shown in the accompanying drawings. When the following description relates to the accompanying drawings, the same numbers in different accompanying drawings indicate the same element or similar elements unless otherwise indicated. The implementations described in the following example embodiments do not represent all implementations consistent with the one or more embodiments of the present specification. On the contrary, they are merely examples of apparatuses and methods consistent with some aspects of the one or more embodiments of the present specification as detailed in the claims.

It is worthwhile to note that in other embodiments, the steps of the corresponding method are not necessarily performed in the order shown and described in the present specification. In some other embodiments, the method can include more or fewer steps than the steps described in the present specification. Further, a single step described in the present specification may be divided into multiple steps for description in other embodiments; and multiple steps described in the present specification may be combined into a single step for description in other embodiments.

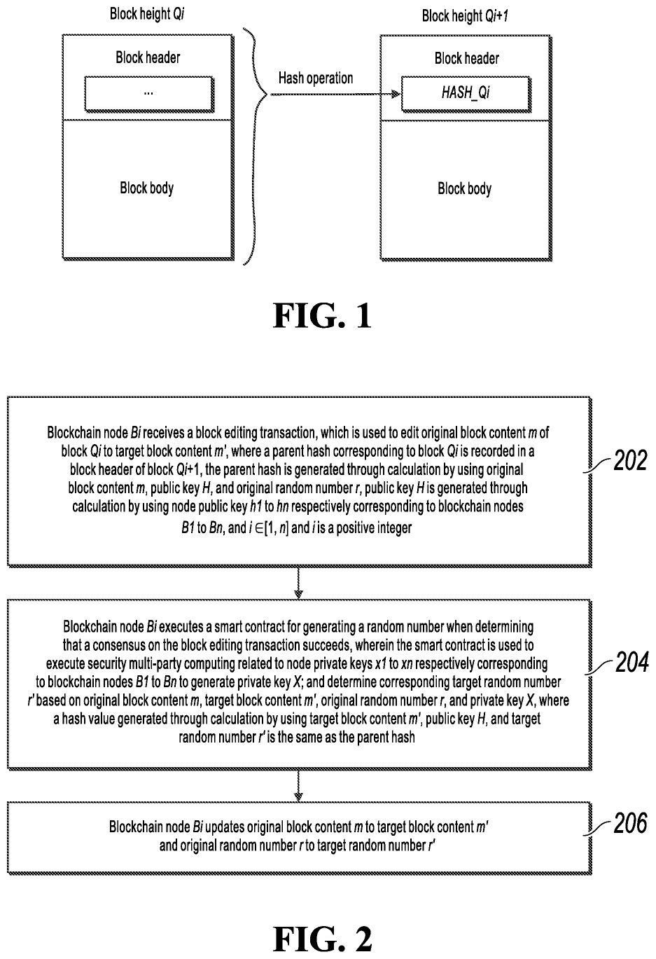

A blockchain is formed by chaining several blocks in sequence, and tamper-resistance of content of the blockchain is related to an anchoring relationship between adjacent blocks. FIG. 1 is a schematic diagram illustrating a blockchain structure according to an example embodiment. As shown in FIG. 1, the anchoring relationship is described by taking two blocks with block heights of Qi and Qi+1 as an example. For ease of understanding, a block with the block height of Qi is referred to as block Qi, and a block with a block height of Qi+1 is referred to as block Qi+1.

Block Qi and block Qi+1 have the same structure and each includes a block header and a block body. In practice, all blocks have the same structure. A block header of block Qi+1 includes information HASH_Qi shown in FIG. 1. HASH_Qi is a parent hash included in block Qi+1, and the parent hash HASH_Qi is obtained by performing a hash operation on content of block Qi. Because block Qi and block Qi+1 are adjacent blocks and block Qi is created earlier than block Qi+1, block Qi can be considered as a parent block of block Qi+1 and a hash generated based on the content of block Qi is referred to as the parent hash. Similarly, if block Qi also has a corresponding parent block, a block header of block Qi can also include a parent hash corresponding to the parent block; or if block Qi is a genesis block, i.e. block Qi does not have a parent block, the block header of block Qi does not have to include the parent hash.

The hash operation can be performed on any input content and a corresponding hash value can be output. In addition, due to the characteristic of the hash operation, it almost can be considered that there is a one-to-one mapping relationship between input content and hash values, and there is only very small probability that a hash collision may occur, i.e. different input content generates the same hash value. In the related technologies, the occurrence probability of the hash collision can be reduced as much as possible in various ways, such as enlarging value space of hash values, so that the hash collision is almost negligible. Therefore, the content of block Qi can be anchored by including parent hash HASH_Qi in the block header of block Qi+1. Because a change in the content of block Qi results in a different hash value from parent hash HASH_Qi, it is very easy to find that the content of block Qi is tampered with.

However, in some applications, for example, private data may be recorded on the blockchain without being encrypted, resulting in a risk of privacy exposure. For another example, erroneous data may be recorded on the blockchain, resulting in a waste of storage space on the blockchain. In conclusion, there is a block content editing need for a chained block. Block content editing solutions provided in the present specification are described below.

FIG. 2 is a flowchart illustrating a block content editing method according to an example embodiment. As shown in FIG. 2, the method can include the following steps:

Step 202: Blockchain node Bi receives a block editing transaction, which is used to edit original block content m of block Qi to target block content m′, wherein a parent hash corresponding to block Qi is recorded in a block header of block Qi+1, the parent hash is generated through calculation by using original block content m, public key H, and original random number r, public key H is generated through calculation by using node public keys h1 to hn respectively corresponding to blockchain nodes B1 to Bn, and i □[1, n] and i is a positive integer.

Blockchain node Bi can be any node in a blockchain network and does not particularly refer to a certain node. In practice, due to the distribution characteristic of blockchain technologies, each blockchain node in the blockchain network performs the same operation to ensure the consistency of blockchain data respectively maintained by each blockchain node. Therefore, each blockchain node can be considered as blockchain node Bi.

Based on the related technologies, a type field can be added to a blockchain transaction, so that blockchain node Bi can distinguish between different types of blockchain transactions based on a value of the type field. For example, the value of type field being 0 corresponds to a block editing transaction, and the value of type field being 1 corresponds to another blockchain transaction. Certainly, different types of blockchain transactions can be distinguished from each other in other ways. Implementations are not limited in the present specification. The block editing transaction is created by a certain transaction initiator and then sent to the blockchain network. The transaction initiator can be a certain user. Blockchain node Bi can receive the block editing transaction from a client device used by the transaction initiator. Alternatively, the transaction initiator can send the block editing transaction to blockchain node Bj by using the client device, and blockchain node Bi can receive the block editing transaction from blockchain node Bj.

Generally, block content should be prevented from being randomly edited. For example, blockchain node Bi can determine the transaction initiator of the block editing transaction, and edit the block content of block Qi based on the block editing transaction when the transaction initiator has an editing permission for block Qi. Otherwise, the block editing transaction may not be executed. Blockchain node Bi can manage the editing permission in various ways. For example, information about a blockchain administrator can be recorded in a genesis block of the blockchain, and blockchain node Bi can consider that the transaction initiator has the editing permission only when the transaction initiator is the blockchain administrator. This way is applicable to all blocks included in the blockchain. For another example, a list of accounts having the editing permission can be included in block Qi, and blockchain node Bi can consider that the transaction initiator has the editing permission only when the transaction initiator belongs to the account list. This way is equivalent to maintaining one account list in each block, wherein account lists maintained in different blocks are independent from each other, thereby realizing block-level editing permission management with relatively higher flexibility.

Assume that the blockchain network includes n blockchain nodes, i.e. previously-mentioned blockchain nodes B1 to Bn, and each blockchain node maintains a node public-private key pair corresponding to identity information of the blockchain node, for example, blockchain node B1 corresponds to node public key h1 and node private key x1, and blockchain node B2 corresponds to node public key h2 and node private key x2, . . . , and blockchain node Bn corresponds to node public key hn and node private key xn. Blockchain node Bi needs to self-maintain node private key xi of the blockchain node Bi and prevent node private key xi from being leaked, and node public key hi needs to be shared with other blockchain nodes, so that each blockchain node can know node public keys h1 to hn and then can generate public key H based on node public keys h1 to hn, for generating the parent hash and performing a subsequent block editing process.

Step 204: Blockchain node Bi executes a smart contract that generates a random number when determining that a consensus on the block editing transaction succeeds, wherein the smart contract is used to execute secure multi-party computing related to node private keys x1 to xn respectively corresponding to blockchain nodes B1 to Bn to generate private key X; and determine corresponding target random number r′ based on original block content m, target block content m′, original random number r, and private key X, wherein a hash value generated through calculation by using target block content m′, public key H, and target random number r′ is the same as the parent hash.

Blockchain nodes B1 to Bn need to perform the consensus on the block editing transaction. When the consensus on the block editing transaction succeeds, it indicates that each blockchain nodes agrees to edit the block content of block Qi based on the block editing transaction, and then the blockchain nodes execute the block editing transaction to edit the block content of block Qi. Blockchain nodes B1 to Bn can perform the consensus by using any type of consensus algorithm. Implementations are not limited in the present specification.

In a blockchain network using consensus algorithms such as proof of work (POW), proof of stake (POS), or delegated proof of stake (DPOS), a consensus process includes a competition for a bookkeeping right among blockchain nodes. Ethereum is taken as an example. Nodes in Ethereum are also generally nodes competing for the bookkeeping right. The blockchain nodes can perform the block editing transaction locally as nodes competing for the bookkeeping right. A certain node in all the nodes competing for the bookkeeping right becomes a bookkeeping node when winning in the current round of competition for the bookkeeping right Assume that the blockchain node becomes the bookkeeping node when winning in the current round of competition for the bookkeeping right. Certainly, if the blockchain node does not win in the current round of competition for the bookkeeping right, the blockchain node is not the bookkeeping node, and another node may become the bookkeeping node. With regard to the blockchain network competing for the bookkeeping right, after the blockchain node in the present specification performs verification on the received block editing transaction before the consensus, if the verification succeeds, the blockchain node broadcasts the block editing transaction to the other blockchain nodes in the blockchain network, so that no matter which node is the bookkeeping node in the current round, the bookkeeping node can package the block editing transaction (or further package other transactions together) and generate a new block, and send the new block to non-bookkeeping nodes for the consensus, the non-bookkeeping nodes can add the new block to the end of the original blockchain when verification performed by the non-bookkeeping nodes on the received new block succeeds, thereby completing the bookkeeping process and reaching the consensus. If the verification performed by the blockchain node in the present specification on the block editing transaction before the consensus fails, the blockchain node does not broadcast the block editing transaction to the other blockchain nodes.

In a blockchain network using a mechanism such as practical byzantine fault tolerance (PBFT), a node having a bookkeeping right is determined through negotiation before the current round of bookkeeping. Therefore, after the blockchain node receives the block editing transaction, assume that verification on the block editing transaction before the consensus succeeds, the blockchain node sends the block editing transaction to the bookkeeping node when the blockchain node is not the bookkeeping node in the current round; or packages the block editing transaction (or further packages other transactions together) and generates a new block, and then sends the generated new block to non-bookkeeping nodes for the consensus when the blockchain node is the bookkeeping node in the current round. In addition, after the blockchain node receives the block editing transaction, assume that verification on the block editing transaction before the consensus fails, the blockchain node does not send the block editing transaction to the bookkeeping node when the blockchain node is not the bookkeeping node in the current round, and the blockchain node does not package the block editing transaction to generate a new block when the blockchain node is the bookkeeping node in the current round. For the new block generated by the bookkeeping node, the non-bookkeeping nodes can add the new block to the end of the original blockchain after verification performed by the non-bookkeeping nodes on the received new block succeeds, thereby completing the bookkeeping process and reaching the consensus.

In the related technologies, a commonly used hash algorithm f( ) has only one input. For example, if the hash value of block Qi is calculated, an input is the block content m of block Qi, i.e. the hash value is f(m). If block content m needs to be changed to block content m′, it is necessary to just make a hash collision between m and m′ to allow f(m)=f(m′), and such a probability is almost negligible. Therefore, the block content m actually cannot be modified as needed. However, in the technical solutions of the present specification, a used hash algorithm f( ) has two inputs. For example, if the hash value of block Qi is calculated, inputs are block content m and random number r of block Qi, i.e. the hash value is f(m, r). If block content m needs to be changed to block content m′, calculated hash value f(m, r)=f(m′, r′) can be ensured only by identifying random number r′ matching block content m′. Therefore, block content m can be modified to any block content m′ as needed.

Blockchain node Bi cannot randomly generate random number r′, and must use private key X corresponding to public key H. Otherwise, blockchain node Bi may randomly modify the block content. Therefore, in the present specification, a distributed private key management method is used, so that each blockchain node Bi holds only node private key xi, and the generation of private key X is related to all node private keys x1 to xn. In this case, any blockchain node can be prevented from obtaining private key X provided that each blockchain node maintains a node private key hold by that blockchain node and a certain blockchain node is prevented from holding all the node private keys. The present specification further provides a method for implementing secure multi-party computing by using the smart contract to generate private key X and then generate random number r′ based on private key X, thereby satisfying the node content editing needs while preventing the node private key or private key X from being exposed.

A smart contract can be deployed and invoked for any one of a public blockchain, a private blockchain, and a consortium blockchain. Ethereum is taken as an example. Users are supported in creating and/or invoking some complex logic in an Ethereum network. It is the biggest challenge for distinguishing Ethereum from bitcoin blockchain technologies. The core of Ethereum serving as a programmable blockchain is an Ethereum virtual machine (EVM), and each Ethereum node can run an EVM. The EVM is a Turing-complete virtual machine. It means that various types of complex logic can be implemented by using the EVM. Users publish and invoke smart contracts on the EVM.

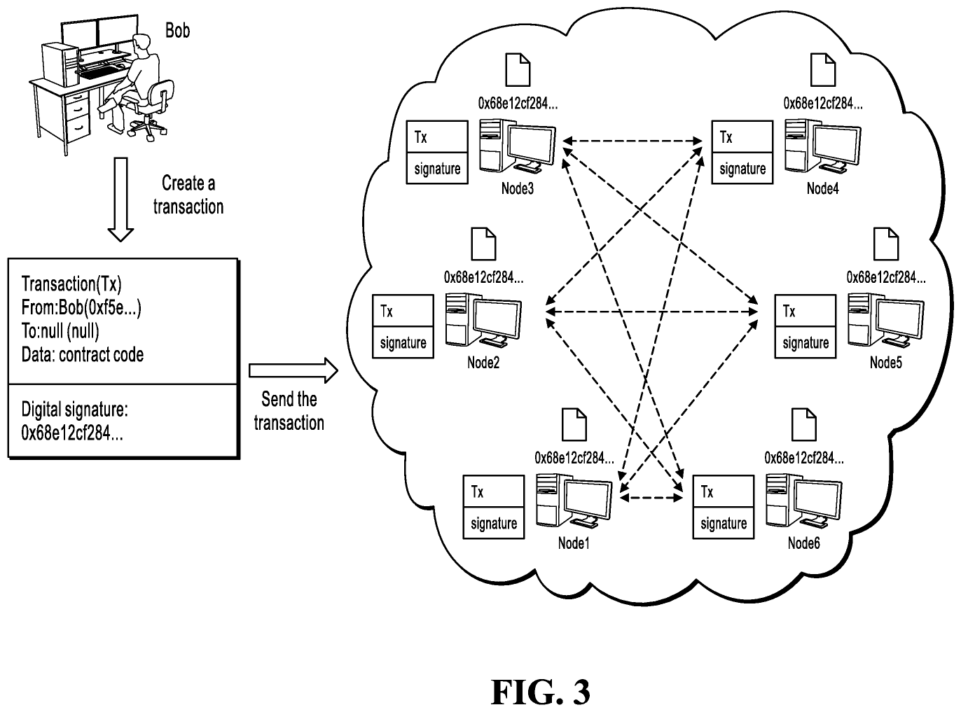

For example, as shown in FIG. 3, after Bob sends a transaction including information about creating a smart contract to an Ethereum network, an EVM of node 1 can execute the transaction and generate a corresponding contract instance. A data field of the transaction can save code (for example, bytecode) of the smart contract, and a to field of the transaction is an empty account. After nodes reach a consensus by using a consensus mechanism, the contract is successfully created and subsequently a user can invoke the contract. After the contract is created, a contract account corresponding to the smart contract appears on the blockchain and has a specific address. The contract code and account storage are saved in the contract account. Behavior of the smart contract is controlled by using the contract code, and the account storage of the smart contract saves a state of the contract. In other words, the smart contract enables a virtual account including the contract code and the account storage to be generated on the blockchain.

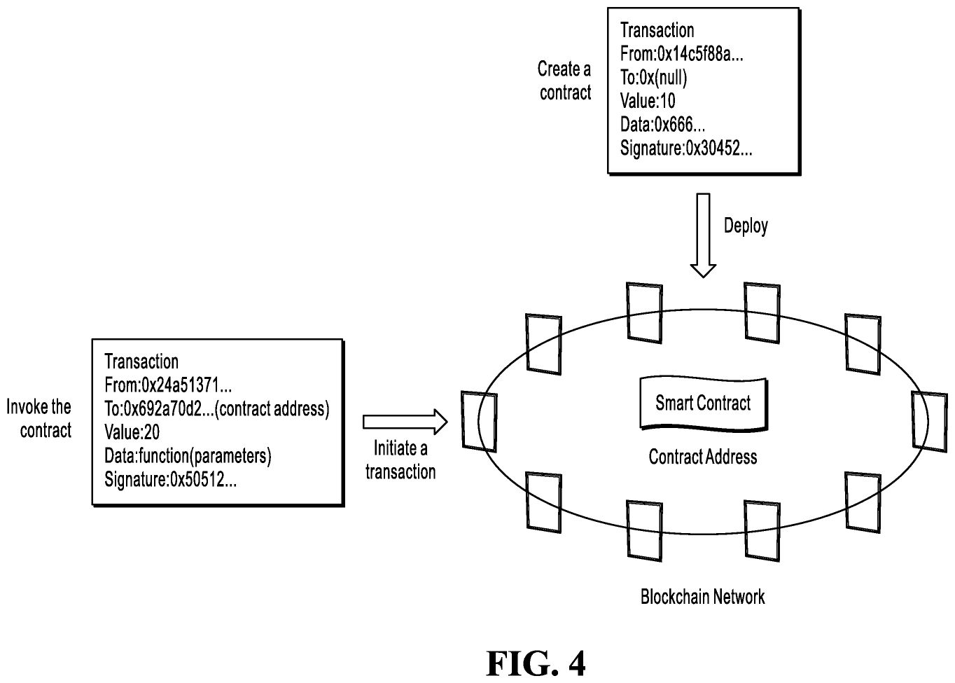

Further, as shown in FIG. 4, Ethereum is still taken as an example. Bob sends a transaction for invoking a smart contract to an Ethereum network, an EVM of node 1 can execute the transaction and generate a corresponding contract instance. In FIG. 4, a from field of the transaction is an address of an account initiating invocation of the smart contract, “0x692a70d2 . . . ” in a to field represents an address of the invoked smart contract, a value field is a value of ETH in Ethereum, and a data field of the transaction saves a method and parameters for invoking the smart contract. The smart contract can be executed independently at each node in the blockchain network in a prescribed way, and all execution records and data are saved on the blockchain. Therefore, when such a transaction is completed, a transaction certificate that cannot be tampered with or lost is saved on the blockchain.

Contract code included in the smart contract is pre-defined and checkable, and the corresponding contract code can be automatically executed after the smart contract is invoked, to implement a predefined logical function, which can ensure that the smart contract always can independently and faithfully accomplish a calculation task. Therefore, in applying the smart contract to a block editing process, the smart contract can implement calculation of private key X and random number r′ without leaking private key X or data used to calculate private key X to the blockchain node, and the whole calculation process is equivalent to a “black box” for the blockchain node, thereby preventing the blockchain node from holding private key X or the data used to calculate private key X.

Private keys x1 to xn and derived data thereof can be shared among blockchain nodes B1 to Bn by using a secret sharing algorithm, and shared data obtained by each blockchain node is the data used to calculate private key X. For example, blockchain node Bi can fragment node private key xi maintained by the blockchain node Bi by using the secret sharing algorithm, to obtain private key fragments xi_1 to xi_n. For example, blockchain node B1 processes node private key x1 into private key fragments x1_1 to x1_n, blockchain node B2 processes node private key x2 into private key fragments x2_1 to x2_n, . . . , and blockchain node Bn processes node private key xn into private key fragments xn_1 to xn_n. Then, blockchain node Bi can share private key fragment xi_j with blockchain node Bj, where j□[1, i−1]∪[i+1, n] and j is a positive integer. For example, when i=1, blockchain node B1 shares private key fragment x1_2 with blockchain node B2, shares private key fragment x1_3 with blockchain node B3, . . . , and shares private key fragment x1_n with blockchain node Bn. For another example, when i=2, blockchain node B2 shares private key fragment x2_1 with blockchain node B1, shares private key fragment x2_3 with blockchain node B3, . . . , and shares private key fragment x2_n with blockchain node Bn, so that blockchain node Bi can finally obtain private key fragment xi_i generated by the blockchain node Bi and private key fragments xj_i respectively shared by other blockchain nodes Bj. It is equivalent that blockchain node Bi can finally obtain private key fragments x1_i to xn_i. For example, blockchain node B1 obtains private key fragments x1_1 to xn_1, blockchain node B2 obtains private key fragments x1_2 to xn_2, . . . , and blockchain node Bn obtains private key fragments x1_n to xn_n.

In this case, when the block content of block Qi needs to be edited, each blockchain node needs to share private key fragments obtained by the blockchain node, to recover private key X. For example, blockchain node Bi can recover private key fragments x1_i to xn_i maintained by blockchain node Bi by using the secret sharing algorithm, to obtain intermediate fragment xi′. Then, each blockchain node can share an intermediate fragment generated by the blockchain node, so that each blockchain node can obtain intermediate fragments x1′ to xn′. In this case, when invoking the smart contract, blockchain node Bi can use intermediate fragments x1′ to xn′ as input parameters of the smart contract, so that the smart contract can recover intermediate fragments x1′ to xn′ by using the secret sharing algorithm, to obtain private key X and then generate random number r′.

In a process of invoking and executing the smart contract, blockchain node Bi may need to cache intermediate fragments x1′ to xn′ and private key X generated in the process. To prevent an untrusted application on blockchain node Bi from reading intermediate fragments x1′ to xn′ or private key X from a cache, a trusted execution environment (TEE) can be deployed on blockchain node Bi, and execution of the smart contract in the TEE can be ensured.

The TEE is a security extension based on CPU hardware and is completely isolated from the outside. The TEE was originally proposed by the Global Platform to implement secure isolation between resources on mobile devices, and is parallel to an operating system to provide a trusted secure execution environment for an application. The trust zone technology of ARM was the first to implement the real commercial TEE technology. With the rapid development of the Internet, the demand for security is increasingly high, in addition to mobile devices, cloud devices and data centers propose more demands for the TEE. The concept of TEE has also been rapidly developed and expanded. The TEE now has a much broader concept than the originally proposed concept. For example, server chip vendors such as Intel and AMD have introduced hardware-assisted TEEs and enriched the concept and characteristics of the TEE, which have been widely recognized in industry. The TEE now commonly refers to such a hardware-assisted TEE technology in more cases. Unlike a mobile terminal, cloud access requires remote access and users of end-user devices are invisible to a hardware platform. Therefore, the first step in using the TEE is to confirm authenticity of the TEE. Therefore, all TEE technologies now introduce a remote attestation mechanism endorsed by a hardware vendor (mainly by a CPU vendor), and it is ensured that users can verify a TEE state by using digital signature technologies. However, even the secure resource isolation cannot satisfy security demands, and further data privacy protection is also proposed. Commercial TEEs, including Intel SGX and AMD SEV, also provide a memory encryption technology to confine trusted hardware inside a CPU, where bus and memory data are ciphertext to prevent malicious users from snooping. For example, TEE technologies such as Intel Software Guard Extension (SGX) isolate code execution, remote attestation, security configuration, secure data storage, and trusted paths for code execution. Applications running in the TEE are secured and hardly accessible to third parties.

The Intel SGX technology is taken as an example. SGX provides an enclave, namely, an encrypted trusted execution area in a memory, where data is protected by the CPU from being stolen. For example, a first blockchain node uses a CPU supporting SGX. A partial area, an enclave page cache (EPC), can be allocated in the memory by using a newly added processor instruction, and data in the EPC is encrypted by using a memory encryption engine (MEE) in the CPU. The encrypted content in the EPC is decrypted into plaintext only after entering the CPU. Therefore, in SGX, users can distrust an operating system, a virtual machine monitor (VMM), and even a basic input output system (BIOS), and only need to trust the CPU to ensure that private data is not leaked. In practice, the private data can be encrypted and transferred to the enclave in the form of ciphertext, and a corresponding key can also be transferred to the enclave through remote attestation. Then, the data is used for calculation under encryption protection of the CPU, and a result is returned in the form of ciphertext. In this mode, strong computing power can be used without concern for data leakage.

The smart contract can further actively delete generated private key X, for example, clear cache space for storing private key X, after determining target random number r′. Similarly, the smart contract can actively delete intermediate fragments x1′ to xn′, for example, clear cache space for storing intermediate fragments x1′ to xn′, after determining private key X. The cache space is actively cleared, so that an untrusted application can be prevented from stealing private key X or intermediate fragments x1′ to xn′ from the cache, thereby improving security.

The related technologies include many hash algorithms that satisfy the operation demands of the present specification, such as a chameleon hash algorithm. Taking the chameleon hash algorithm as an example, a hash value calculation formula is: HASH=g\hat{ }a*H\hat{ }B, where g is a predetermined generator, H is a public key, a is data, and b is a random number. For example, when a is block content m, b is random number r; or when a is block content m′, b is random number r′. Therefore, parent hash HASH_Qi=g\hat{ }m*H\hat{ }r can be calculated.

Because the node public-private key pair satisfies hi=g\hat{ }xi, public key H=h1*h2* . . . *hn and private key X=x1+x2+ . . . +xn are set, and then the parent hash is obtained as follows: HASH_Qi=g\hat{ }m*H\hat{ }r=g\hat{ }m*(h1*h2* . . . *hn)\hat{ }r=g\hat{ }m*(g\hat{ }x1*g\hat{ }x2* . . . *g\hat{ }xn)\hat{ }r=g\hat{ }[m+(x1+x2+ . . . +xn)*r]=g\hat{ }(m+Xr). Similarly, a corresponding parent hash obtained after block editing can be calculated as follows: HASH_Qi′=g\hat{ }m′*H\hat{ }r′=g\hat{ }m′*(h1*h2* . . . *hn)\hat{ }r′=g\hat{ }m′*(g\hat{ }x1*g\hat{ }x2* . . . *g\hat{ }xn)\hat{ }r′=g\hat{ }[m′+(x1+x2+ . . . +xn)*r′]=g\hat{ }(m′+Xr′). Because the parent hash values obtained before and after the block editing need to be consistent, namely, HASH_Qi=HASH_Qi′, g\hat{ }(m+Xr)=g\hat{ }(m′+Xr′) can be obtained, and then random number r′=(m+Xr−m′)/X can be determined.

It can be seen that private key X can be calculated by using the smart contract, and random number r′ can be calculated by using private key X, random number r, block content m, and block content m′. In addition, because values of random number r, block content m, and block content m′ are all known, private key X is the central factor for successfully calculating random number r′. Therefore, private key X and the data used to calculate private key X need to be encrypted in the previously described way. Otherwise, the block content can be randomly modified based on private key X and the data used to calculate private key X, resulting in a security risk.

Step 206: Blockchain node Bi updates original block content m to target block content m′ and original random number r to target random number r′.

Blockchain node Bi needs to add the hash value of block Qi, namely, parent hash HASH_Qi, to the block header of the block Qi+1 when generating block Qi+1. Because the calculation of parent hash HASH_Qi relates to block content m, random number r, and public key H, and both block content m and random number r are fixed, the value of parent hash HASH_Qi is affected by public key H. The public key H is calculated by using node public keys h1 to hn corresponding to the blockchain nodes. Therefore, in the process of generating block Qi+1, blockchain node Bi needs to determine node public key hi used for block Qi, send determined node public key hi to the other blockchain nodes, and receive node public keys used for block Qi that are determined by the other blockchain nodes, so that each blockchain node finally obtains node public key h1 to hn, to generate public key H and then generate parent hash HASH_Qi.

If the node public-private key pair used by each blockchain node keeps unchanged, i.e. blockchain node Bi always uses public-private key pair (hi, xi), the value of public key H also keeps unchanged, so that the blockchain node needs to share the node public key only once, instead of sharing the node public key when each block is generated. However, long-term invariance of the public-private key pair may lead to a security risk. Therefore, the blockchain node can periodically or temporarily change the used public-private key pair. As such, even if some public-private key pairs are leaked, not all blocks are at risk of being tampered with. If a periodical change method is used, all the blockchain nodes change the public-private key pairs used by the blockchain nodes based on a fixed period, and the blockchain nodes can share the changed node public key in the process of generating the first block after each change, but do not need to share the changed node public key in the rest of the same period. If a temporary change method is used, each blockchain node cannot determine whether the other blockchain nodes are to change their public-private key pairs. Therefore, it is necessary to share the node public key each time a block is generated. The temporary change method is more random than the periodic change method, thereby achieving higher security.

As previously described, if the node public-private key pair used by each blockchain node is unchanged, blockchain node Bi inevitably uses the same public-private key pair for different blocks, so that the number of sharing times of the node public key can be minimized. However, if the blockchain node changes the public-private key pair, blockchain node Bi uses different public-private key pairs for at least two blocks. So that blockchain node Bi needs to record a mapping relationship between each block and a correspondingly used public-private key pair. As such, in the subsequent editing for the block content of block Qi, the block content of block Qi can be edited based on the mapping relationship. For example, it can be ensured that blockchain node Bi uses a correct private key fragment to generate a corresponding intermediate fragment, and then correct private key X is ensured.

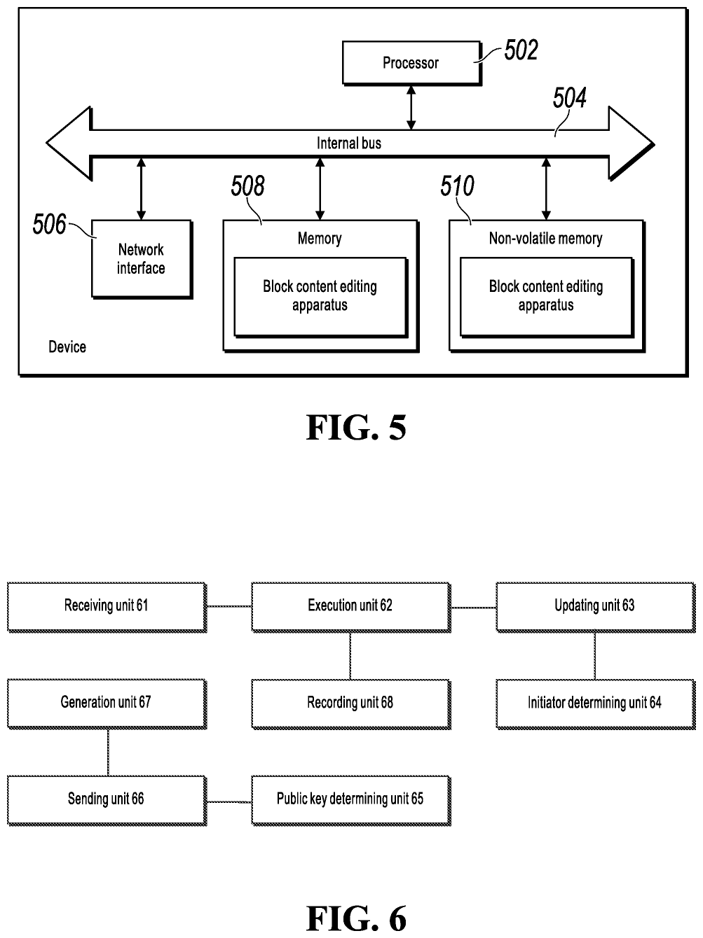

FIG. 5 is a schematic structural diagram illustrating a device according to an example embodiment. Referring to FIG. 5, at a hardware level, the device includes a processor 502, an internal bus 504, a network interface 506, a memory 508, and a non-volatile memory 510. Certainly, the device may further include hardware needed by other services. The processor 502 reads a corresponding computer program from the non-volatile memory 510 to the memory 508 and then runs the computer program to form a block content editing apparatus at a logical level. Certainly, in addition to a software implementation, the one or more embodiments of the present specification do not exclude other implementations, such as a logic device or a combination of hardware and software, i.e. an execution body of the following processing procedure is not limited to each logic unit, and can be a hardware or logic device.

Referring to FIG. 6, in the software implementation, the block content editing apparatus can include:

a receiving unit 61, configured to enable blockchain node Bi to receive a block editing transaction, which is used to edit original block content m of block Qi to target block content m′, where a parent hash corresponding to block Qi is recorded in a block header of block Qi+1, the parent hash is generated through calculation by using original block content m, public key H, and original random number r, public key H is generated through calculation by using node public keys h1 to hn respectively corresponding to blockchain nodes B1 to Bn, and i□[1, n] and i is a positive integer

an execution unit 62, configured to enable blockchain node Bi to execute a smart contract that generates a random number when determining that a consensus on the block editing transaction succeeds, where the smart contract is used to execute secure multi-party computing related to node private keys x1 to xn respectively corresponding to blockchain nodes B1 to Bn to generate private key X; and determine corresponding target random number r′ based on original block content m, target block content m′, original random number r, and private key X, where a hash value generated through calculation by using target block content m′, public key H, and target random number r′ is the same as the parent hash; and

an updating unit 63, configured to enable blockchain node Bi to update original block content m to target block content m′ and original random number r to target random number r′.

Optionally, the execution unit 62 generates private key X through secure multi-party computing, including the following:

obtaining intermediate fragments x1′ to xn′, where intermediate fragment xi′ is obtained by blockchain node Bi by recovering private key fragments x1_i to xn_i by using a secret sharing algorithm, private key fragments xi_1 to xi_n are obtained by blockchain node Bi by fragmenting node private key xi by using the secret sharing algorithm, xi_j is shared with by blockchain node Bi blockchain node Bj, and j□[1, i−1]∪[i+1, n] and j is a positive integer; and

recovering intermediate fragments x1′ to xn′ by using the secret sharing algorithm, to obtain private key X.

Optionally, the execution unit 62 is specifically configured to:

execute the smart contract that generates the random number in a trusted execution environment deployed on blockchain node Bi.

Optionally, the smart contract is further used to delete generated private key X when target random number r′ is determined.

Optionally, public key H is a product of node public keys h1 to hn, private key X is a sum of node private keys x1 to xn, and hi=g\hat{ }xi when a hash value is calculated by using a formula g\hat{ }a*H\hat{ }B, where

g is a predetermined generator; and a=m and b=r, or a=m′ and b=r′.

Optionally, the block content editing apparatus further includes:

an initiator determining unit 64, configured to enable blockchain node Bi to determine a transaction initiator of the block editing transaction; and

the updating unit 63 is configured to enable blockchain node Bi to update the block content of block Qi based on the block editing transaction when the transaction initiator has an editing permission for block Qi.

Optionally, the block content editing apparatus further includes:

a public key determining unit 65, configured to enable blockchain node Bi to determine node public key hi used for block Qi in a process of generating block Qi+1;

a sending unit 66, configured to enable blockchain node Bi to send determined node public key hi to the other blockchain nodes, and receive node public keys used for block Qi that are determined by the other blockchain nodes, to obtain node public keys h1 to hn; and

a generation unit 67, configured to enable blockchain node Bi to generate the parent hash based on public key H corresponding to node public keys h1 to hn, and add the parent hash to the block header of block Qi+1.

Optionally, blockchain node Bi uses the same public-private key pair for different blocks; or

when blockchain node Bi uses different public-private key pairs for at least two blocks, the apparatus further includes: a recording unit 68, configured to enable blockchain node Bi to record a mapping relationship between each block and a correspondingly used public-private key pair to edit the block content of block Qi based on the mapping relationship.

The systems, methods, modules, or units illustrated in the previous embodiments can be implemented by using a computer chip or an entity, or can be implemented by using a product having a certain function. A typical implementation device is a computer. A specific form of the computer can be a personal computer, a laptop computer, a cellular phone, a camera phone, a smartphone, a personal digital assistant, a media player, a navigation device, an email sending/receiving device, a game console, a tablet computer, a wearable device, or a combination of any several of these devices.

In a typical configuration, the computer includes one or more processors (CPUs), input/output interfaces, network interfaces, and memories.

The memory may include forms such as a non-persistent memory, a random access memory (RAM), and/or a non-volatile memory in a computer-readable medium, such as a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of the computer storage medium include but are not limited to a phase-change random access memory (PRAM), a static random access memory (SRAM), a dynamic random access memory (DRAM), a random access memory (RAM) of another type, a read-only memory (ROM), an electrically erasable programmable ROM (EEPROM), a flash memory or another memory technology, a compact disc read-only memory (CD-ROM), a digital versatile disc (DVD) or another optical storage, a cassette, a magnetic disk storage, a quantum memory, a graphene-based storage medium or another magnetic storage device, or any other non-transmission medium. The computer storage medium can be configured to store information accessible to a computing device. As described in the present specification, the computer-readable medium does not include computer-readable transitory media such as a modulated data signal and a carrier.

It is worthwhile to note that the terms “comprise”, “include”, or any other variation thereof are intended to cover a non-exclusive inclusion, so that a process, method, product, or device that includes a list of elements includes those elements and further includes other elements not expressly listed or inherent to such a process, method, product, or device. An element proceeded by the phrase “comprise a . . . ” does not, without more constraints, preclude the existence of additional identical elements in a process, method, product, or device that includes the element.

The specific embodiments of the present specification are previously described. Other embodiments fall within the scope of the appended claims. In some cases, the actions or steps in the claims can be performed in different orders from the orders in the embodiments and still can achieve the desired results. In addition, the processes illustrated in the accompanying drawings do not necessarily require the shown specific order or sequence to achieve the desired results. In some implementations, multitasking and parallel processing are also possible or may be advantageous.

The terms used in the one or more embodiments of the present specification are intended merely for the purpose of describing specific embodiments and are not intended to limit the one or more embodiments of the present specification. As used in the one or more embodiments of the present specification and the claims, singular forms “a”, “an” and “the” are also intended to include plural forms, unless otherwise specified in the context clearly. It should also be understood that the term “and/or” used in the present specification refers to and includes any or all possible combinations of one or more associated listed items.

It should be understood that, although terms “first”, “second”, “third”, etc. may be used in describing various types of information in the one or more embodiments of the present specification, such information should not be limited to such terms. These terms are only used to distinguish between information of the same type. For example, first information can also be referred to as second information, and similarly, second information can also be referred to as first information, without departing from the scope of the one or more embodiments of the present specification. Depending on the context, the word “if” used here can be interpreted as “at the time of”, “when” or “in response to determining”.

The previous descriptions are merely preferred embodiments of the one or more embodiments of the present specification, and are not intended to limit the one or more embodiments of the present specification. Any modification, equivalent substitution, improvement, etc. made within the spirit and principles of the one or more embodiments of the present specification shall fall within the protection scope of the one or more embodiments of the present specification.

What is claimed is:

1. A computer-implemented method comprising:
receiving, by a blockchain node Bi, a transaction to edit original block content m of a block Qi to target block content m′, wherein a parent hash of the block Qi is recorded in a block header of a block Qi+1, wherein the parent hash is generated based on the original block content m, a public key H, and an original random number r, and wherein the public key H is calculated based on public keys h1 to hn respectively corresponding to blockchain nodes B1 to Bn, and i∈[1, n] and i is a positive integer;
in response to determining that a consensus on the transaction succeeds, generating a private key X by the blockchain node Bi, by executing a smart contract based on private keys x1 to xn respectively corresponding to the blockchain nodes B1 to Bn;
determining a target random number r′, by the blockchain node Bi, by executing the smart contract based on the original block content m, the target block content m′, the original random number r, and the private key X, wherein a hash value generated using the target block content m′, the public key H, and the target random number r′ is the same as the parent hash; and
updating, by the blockchain node Bi, the original block content m to the target block content m′ and the original random number r to the target random number r′.

2. The computer-implemented method according to claim 1, wherein generating the private key X by the blockchain node Bi, by executing the smart contract based on the private keys x1 to xn respectively corresponding to the blockchain nodes B1 to Bn comprises generating the private key X through secure multi-party computing.

3. The computer-implemented method according to claim 2, wherein generating the private key X through secure multi-party computing comprises:
obtaining intermediate fragments x1′ to xn′, wherein an intermediate fragment xi′ is obtained by the blockchain node Bi via recovering private key fragments x1_i to xn_i using a secret sharing algorithm, wherein the private key fragments xi_1 to xi_n are obtained by the blockchain node Bi via fragmenting a private key xi using the secret sharing algorithm, and wherein xi_j is shared by the blockchain node Bi with a blockchain node Bj, and j∈[1, i−1]∪[i+1, n] and j is a positive integer; and
obtaining the private key X by recovering the intermediate fragments x1′ to xn′ using the secret sharing algorithm.

4. The computer-implemented method according to claim 1, wherein the smart contract is executed in a trusted execution environment deployed on the blockchain node Bi.

5. The computer-implemented method according to claim 1, wherein the smart contract is further used to delete the private key X after determining the target random number r′.

6. The computer-implemented method according to claim 1, wherein the public key H is a product of the public keys h1 to hn, and wherein the private key X is a sum of the private keys x1 to xn, and hi=g\hat{ }xi when the hash value is calculated by using a formula g\hat{ }a*H\hat{ }B, wherein
g is a predetermined generator; and
a=m and b=r, or a=m′ and b=r′.

7. The computer-implemented method according to claim 1, further comprising:
determining, by the blockchain node Bi, a transaction initiator of the transaction;
determining, by the blockchain node Bi, the transaction initiator of the transaction has an editing permission for the block Qi; and
in response to determining that the transaction initiator of the transaction has the editing permission for the block Qi, executing the transaction by the blockchain node Bi.

8. The computer-implemented method according to claim 1, further comprising:
determining, by the blockchain node Bi, a public key hi used for the block Qi in generating the block Qi+1;
sending, by the blockchain node Bi, the public key hi to other blockchain nodes;
receiving, by the blockchain node Bi, public keys used for the block Qi from the other blockchain nodes to obtain the public keys h1 to hn;
generating, by the blockchain node Bi, the parent hash based on the public key H corresponding to the public keys h1 to hn; and
adding, by the blockchain node Bi, the parent hash to the block header of the block Qi+1.

9. The computer-implemented method according to claim 1, wherein the blockchain node Bi uses:
a same public-private key pair for a plurality of blocks; or
different public-private key pairs for at least two blocks, and the computer-implemented method further comprises: recording, by the blockchain node Bi, a mapping relationship between each block and a correspondingly used public-private key pair, wherein the mapping relationship is used in editing the block content of the block Qi.

10. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
receiving, by a blockchain node Bi, a transaction to edit original block content m of a block Qi to target block content m′, wherein a parent hash of the block Qi is recorded in a block header of a block Qi+1, wherein the parent hash is generated based on the original block content m, a public key H, and an original random number r, and wherein the public key H is calculated based on public keys h1 to hn respectively corresponding to blockchain nodes B1 to Bn, and i∈[1, n] and i is a positive integer;
in response to determining that a consensus on the transaction succeeds, generating a private key X by the blockchain node Bi, by executing a smart contract based on private keys x1 to xn respectively corresponding to the blockchain nodes B1 to Bn;
determining a target random number r′, by the blockchain node Bi, by executing the smart contract based on the original block content m, the target block content m′, the original random number r, and the private key X, wherein a hash value generated using the target block content m′, the public key H, and the target random number r′ is the same as the parent hash; and
updating, by the blockchain node Bi, the original block content m to the target block content m′ and the original random number r to the target random number r′.

11. The computer-implemented system according to claim 10, wherein generating the private key X by the blockchain node Bi, by executing the smart contract based on the private keys x1 to xn respectively corresponding to the blockchain nodes B1 to Bn comprises:
obtaining intermediate fragments x1′ to xn′, wherein an intermediate fragment xi′ is obtained by the blockchain node Bi via recovering private key fragments x1_i to xn_i using a secret sharing algorithm, wherein the private key fragments xi_1 to xi_n are obtained by the blockchain node Bi via fragmenting a private key xi using the secret sharing algorithm, and wherein xi_j is shared by the blockchain node Bi with a blockchain node Bj, and j∈[1, i−1]∪[i+1, n] and j is a positive integer; and
obtaining the private key X by recovering the intermediate fragments x1′ to xn′ using the secret sharing algorithm.

12. The computer-implemented system according to claim 10, wherein the smart contract is executed in a trusted execution environment deployed on the blockchain node Bi.

13. The computer-implemented system according to claim 10, wherein the smart contract is further used to delete the private key X after determining the target random number r′.

14. The computer-implemented system according to claim 10, wherein the public key H is a product of the public keys h1 to hn, and wherein the private key X is a sum of the private keys x1 to xn, and hi=g\hat{ }xi when the hash value is calculated by using a formula g\hat{ }a*H\hat{ }B, wherein
g is a predetermined generator; and
a=m and b=r, or a=m′ and b=r′.

15. The computer-implemented system according to claim 10, wherein the operations further comprise:
determining, by the blockchain node Bi, a transaction initiator of the transaction;
determining, by the blockchain node Bi, the transaction initiator of the transaction has an editing permission for the block Qi; and
in response to determining that the transaction initiator of the transaction has the editing permission for the block Qi, executing the transaction by the blockchain node Bi.

16. The computer-implemented system according to claim 10, wherein the operations further comprise:
determining, by the blockchain node Bi, a public key hi used for the block Qi in generating the block Qi+1;
sending, by the blockchain node Bi, the public key hi to other blockchain nodes;
receiving, by the blockchain node Bi, public keys used for the block Qi from the other blockchain nodes to obtain the public keys h1 to hn;
generating, by the blockchain node Bi, the parent hash based on the public key H corresponding to the public keys h1 to hn; and
adding, by the blockchain node Bi, the parent hash to the block header of the block Qi+1.

17. The computer-implemented system according to claim 10, wherein the blockchain node Bi uses:
a same public-private key pair for a plurality of blocks; or
different public-private key pairs for at least two blocks, and wherein the operations further comprise: recording, by the blockchain node Bi, a mapping relationship between each block and a correspondingly used public-private key pair, wherein the mapping relationship is used in editing the block content of the block Qi.

18. A non-transitory, computer-readable medium storing one or more instructions executable by a computer system to perform operations comprising:
receiving, by a blockchain node Bi, a transaction to edit original block content m of a block Qi to target block content m′, wherein a parent hash of the block Qi is recorded in a block header of a block Qi+1, wherein the parent hash is generated based on the original block content m, a public key H, and an original random number r, and wherein the public key H is calculated based on public keys h1 to hn respectively corresponding to blockchain nodes B1 to Bn, and i∈[1, n] and i is a positive integer;
in response to determining that a consensus on the transaction succeeds, generating a private key X, by the blockchain node Bi, by executing a smart contract based on private keys x1 to xn respectively corresponding to the blockchain nodes B1 to Bn;
determining a target random number r′, by the blockchain node Bi, by executing the smart contract based on the original block content m, the target block content m′, the original random number r, and the private key X, wherein a hash value generated using the target block content m′, the public key H, and the target random number r′ is the same as the parent hash; and
updating, by the blockchain node Bi, the original block content m to the target block content m′ and the original random number r to the target random number r′.

19. The non-transitory, computer-readable medium according to claim 18, wherein generating the private key X, by the blockchain node Bi, by executing the smart contract based on the private keys x1 to xn respectively corresponding to the blockchain nodes B1 to Bn comprises generating the private key X through secure multi-party computing, comprising:
obtaining intermediate fragments x1′ to xn′, wherein an intermediate fragment xi′ is obtained by the blockchain node Bi via recovering private key fragments x1_i to xn_i using a secret sharing algorithm, wherein the private key fragments xi_1 to xi_n are obtained by the blockchain node Bi via fragmenting a private key xi using the secret sharing algorithm, and wherein xi_j is shared by the blockchain node Bi with a blockchain node Bj, and j∈[1, i−1]∪[i+1, n] and j is a positive integer; and
obtaining the private key X by recovering the intermediate fragments x1′ to xn′ using the secret sharing algorithm.

20. The non-transitory, computer-readable medium according to claim 18, wherein the smart contract is executed in a trusted execution environment deployed on the blockchain node Bi.
